(19) United States
(12) Patent Application Publication
(10) Pub. No.: US 2022/0310999 A1
(43) Pub. Date: Sep. 29, 2022

(54) Lithium Secondary Battery and Method of Fabricating Cathode for Lithium Secondary Battery

(71) Applicant: SK ON CO., LTD., Seoul (KR)

(72) Inventors: Sang Min Park, Daejeon (KR); Mi Jung Noh, Daejeon (KR); Jae Ho Choi, Daejeon (KR)

(21) Appl. No.: 17/704,201

(22) Filed: Mar. 25, 2022

(30) Foreign Application Priority Data
Mar. 26, 2021 (KR) 10-2021-0039730

(51) Int. Cl. H01M 4/525; H01M 4/505; H01M 10/0525; H01M 4/04; H01M 4/36

(52) U.S. Cl. CPC H01M 4/525; H01M 4/505; H01M 10/0525; H01M 4/043; H01M 4/0404; H01M 4/364; H01M 2004/021

(57) ABSTRACT

A lithium secondary battery includes a cathode including a cathode current collector and a cathode active material layer formed on the cathode current collector, the cathode active material layer including lithium-transition metal composite oxide particles, and an anode facing the cathode. A BET specific surface area after 300 cycles of the cathode active material layer is in a range from 1.5 m²/g to 2.6 m²/g, when a single cycle includes charging at 1.0 C and 4.2V in a CC/CV mode to a 100% state of charge (SOC) and then discharging at 1.0 C and 2.5V in a CC mode in a temperature range from 20° C. to 45° C.

### CROSS-REFERENCE TO RELATED APPLICATION

This application claims priority to Korean Patent Application No. 10-2021-0039730 filed on Mar. 26, 2021, the disclosure of which is hereby incorporated by reference in its entirety.

### BACKGROUND OF THE INVENTION

### 1. Field of the Invention

The present invention relates to a lithium secondary battery and a method of fabricating a cathode for a lithium secondary battery. More particularly, the present invention relates to a lithium secondary battery including a lithium metal oxide-based cathode active material and a method of fabricating a cathode for the lithium secondary battery.

### 2. Description of Related Art

A secondary battery which can be charged and discharged repeatedly has been widely employed as a power source of a mobile electronic device such as a camcorder, a mobile phone, a laptop computer, etc., according to developments of information and display technologies. Recently, the secondary battery or a battery pack including the same is being developed and applied as an eco-friendly power source of an electric automobile such as a hybrid vehicle.

The secondary battery includes, e.g., a lithium secondary battery, a nickel-cadmium battery, a nickel-hydrogen battery, etc. The lithium secondary battery is highlighted due to high operational voltage and energy density per unit weight, a high charging rate, a compact dimension, etc.

For example, the lithium secondary battery may include an electrode assembly including a cathode, an anode and a separation layer (separator), and an electrolyte immersing the electrode assembly. The lithium secondary battery may further include an outer case having, e.g., a pouch shape.

A lithium metal oxide is used as a cathode active material of the lithium secondary battery which may have preferably properties for high capacity, high power and enhanced life-span. The cathode active material may be coated on a cathode current collector, and then dried and pressed to form a cathode active material layer.

However, damages such as cracks may be caused in cathode active material particles during the pressing process, thereby deteriorating chemical stability and life-span properties of the lithium secondary battery.

For example, Korean Published Patent Application No. 10-2017-0093085 discloses a cathode active material including a transition metal compound and an ion adsorption binder, which may not provide sufficient life-span and stability.

### SUMMARY OF THE INVENTION

According to an aspect of the present invention, there is provided a lithium secondary battery having improved operational stability and reliability.

According to an aspect of the present invention, there is provided a method of fabricating a cathode for a lithium secondary battery having improved operational stability and reliability.

A lithium secondary battery includes a cathode including a cathode current collector and a cathode active material layer formed on the cathode current collector, the cathode active material layer including lithium-transition metal composite oxide particles, and an anode facing the cathode.

A BET specific surface area after 300 cycles of the cathode active material layer is in a range from 1.5 m²/g to 2.6 m²/g, when a single cycle includes charging at 1.0 C and 4.2V in a CC/CV mode to a 100% state of charge (SOC) and then discharging at 1.0 C and 2.5V in a CC mode in a temperature range from 20° C. to 45° C.

In some embodiments, the BET specific surface area of the cathode active material layer after the 300 cycles may be in a range from 1.5 m²/g to 2.3 m²/g.

In some embodiments, an increase ratio of the BET specific surface area of the cathode active material layer after the 300 cycles relative to a BET specific surface area of the cathode active material layer after the single cycle may be 50% or less.

In some embodiments, an increase ratio of the BET specific surface area of the cathode active material layer after the 300 cycles relative to a BET specific surface area of the cathode active material layer after the single cycle may be from 20% to 50%.

In some embodiments, a pore volume of the cathode active material layer after the 300 cycles may be in a range from 0.01 cm³/g to 0.018 cm³/g.

In some embodiments, a pore volume of the cathode active material layer after the 300 cycles may be in a range from 0.01 cm³/g to 0.016 cm³/g.

In some embodiments, the lithium-transition metal composite oxide particle may be represented by Chemical Formula 1:

LiₓNi_{1-y}M_{y}O_{2+z} [Chemical Formula 1]

In Chemical Formula 1, 0.9≤x≤1.2, 0≤y≤0.7, −0.1≤z≤0.1, and M may include at least one element selected from the group consisting of Na, Mg, Ca, Y, Ti, Hf, V, Nb, Ta, Cr, Mo, W, Mn, Co, Fe, Cu, Ag, Zn, B, Al, Ga, C, Si, Sn and Zr.

In some embodiments, a molar ratio of nickel in the lithium-transition metal composite oxide particle may be 0.8 or more.

In some embodiments, a mixture density of the cathode active material layer may be less than 3.8 g/cc.

In some embodiments, a mixture density of the cathode active material layer is greater than 3.6 g/cc and less than 3.8 g/cc.

In a method of fabricating a cathode for a lithium secondary battery, a slurry including a cathode active material that includes lithium-transition metal composite oxide particles is coated on a cathode current collector to form a preliminary cathode active material layer. A cathode active material layer is formed by pressing the preliminary cathode active material layer so that the cathode active material layer has a mixture density of less than 3.8 g/cc and a BET specific surface area in a range from 1.5 m²/g to 2.0 m²/g.

In some embodiments, the BET specific surface area of the preliminary cathode active material layer before the pressing may be from 0.5 m²/g to 1.0 m²/g.

In some embodiments, an increase ratio of the BET specific surface area of the cathode active material layer after the pressing relative to the BET specific surface area of the preliminary cathode active material layer before the pressing may be in a range from 100% to 200%.

In some embodiments, an increase ratio of the BET specific surface area of the cathode active material layer after the pressing relative to the BET specific surface area of the preliminary cathode active material layer before the pressing may be in a range from 100% to 150%.

In some embodiments, a pore volume of the cathode active material layer after the pressing may be in a range from 0.009 cm³/g to 0.015 cm³/g.

In some embodiments, in the formation of the cathode active material layer, a first press of the slurry is performed. A second press is performed by changing press conditions to have a target mixture density or a target BET specific surface area based on a mixture density or a BET specific surface area measured after the first press.

A lithium secondary battery according to the above-described embodiments of the present invention may have a BET specific surface area within a predetermined range after 300 charge/discharge cycles. Within the range of the BET specific surface area, sufficient long-term capacity retention property may be achieved while providing a sufficient level of an electrolyte impregnation.

In some embodiments, the BET specific surface area after the 300 cycles may be adjusted by a mixture density, a BET specific surface area value, etc., after pressing. Accordingly, particle cracks in the pressing process may be prevented in a cathode active material layer while achieving the sufficient electrolyte impregnation level.

In some embodiments, a pore volume in the cathode active material layer may adjusted to a predetermined range, so that gas generation and deterioration of life-span property due to a side reaction with the electrolyte may be effectively suppressed.

### BRIEF DESCRIPTION OF THE DRAWINGS

FIGS. 1 and 2 are schematic top planar view and cross-sectional view, respectively, illustrating a lithium secondary battery in accordance with exemplary embodiments.

FIG. 3 is a graph showing a change of a volume distribution according to a distribution of a pore diameter (dV/dD) in cathodes of Examples and Comparative Examples after performing cycles at 45° C. and a storage at 60° C.

### DESCRIPTION OF THE INVENTION

According to embodiments of the present invention, a lithium secondary battery that included a cathode active material layer having predetermined properties of a density, a specific surface area, a pore, etc., to provide enhanced capacity and life-span properties is provided.

Hereinafter, embodiments of the present invention will be described in detail with reference to experiment examples and drawings. However, the embodiments disclosed herein are exemplary and the present invention is not limited to a specific embodiment.

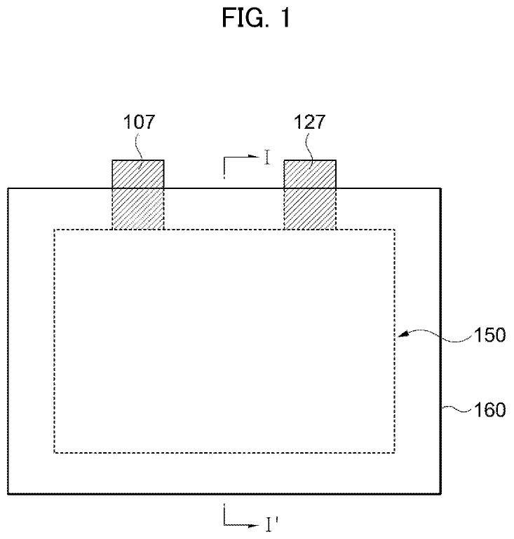

FIGS. 1 and 2 are schematic top planar view and cross-sectional view, respectively, illustrating a lithium secondary battery in accordance with exemplary embodiments. For example, FIG. 2 is a cross-sectional view taken along a line I-I′ of FIG. 1 in a thickness direction.

Referring to FIGS. 1 and 2, the lithium secondary battery may include an electrode assembly including a cathode 100, an anode 130 and a separation layer 140 interposed between the cathode and the anode. The electrode assembly may be accommodated and impregnated with an electrolyte in a case 160.

The cathode 100 may include a cathode active material layer 110 formed by coating a cathode active material on a cathode current collector 105. The cathode active material may include a compound capable of reversibly intercalating and de-intercalating lithium ions.

In exemplary embodiments, the cathode active material may include lithium-transition metal composite oxide particles. For example, the lithium-transition metal composite oxide particle may include nickel (Ni), and may further include at least one of cobalt (Co) and manganese (Mn).

For example, the lithium-transition metal composite oxide particle may be represented by Chemical Formula 1 below.

LiₓNi_{1-y}M_{y}O_{2+z} [Chemical Formula 1]

In Chemical Formula 1, 0.9≤x≤1.2, 0≤y≤0.7, and −0.1≤z≤0.1. M may include at least one of Na, Mg, Ca, Y, Ti, Hf, V, Nb, Ta, Cr, Mo, W, Mn, Co, Fe, Cu, Ag, Zn, B, Al, Ga, C, Si, Sn or Zr.

In some embodiments, a molar ratio or concentration of Ni represented as (1−y) in Chemical Formula 1 may be 0.6 or more, and may be 0.8 or more in a preferred embodiment. For example, the molar ratio of Ni may be 0.85 or more, 0.88 or more, or 0.9 or more.

Ni may serve as a metal related with capacity and power of the lithium secondary battery. Accordingly, as described above, the lithium-transition metal composite metal oxide particle having the high-Ni composition may be employed so that the cathode and the lithium secondary battery having high capacity may be provided.

However, as the content of Ni increases, long-term storage and life-span stability of the cathode or the lithium secondary battery may be relatively degraded. In exemplary embodiments, Co may be introduced to maintain an electrical conductivity and Mn may be introduced to improve properties related to life-span stability and capacity retention.

In some embodiments, the cathode active material or the lithium-transition metal composite oxide particle may further include a coating element or a doping element. For example, the coating element or the doping element may include Al, Ti, Ba, Zr, Si, B, Mg, P, an alloy thereof or an oxide thereof. These may be used alone or in combination of two or more therefrom. The cathode active material particle may be passivated by the coating or doping element, thereby further improving stability to a penetration of an external object and life-span property.

For example, a cathode slurry may be prepared by mixing and stirring the cathode active material including the lithium-transition metal composite oxide particle as described above in a solvent with a binder, a conductive material and/or a dispersive agent. The cathode slurry may be coated on the cathode current collector 105, and then dried and pressed to form the cathode 100.

The cathode current collector 105 may include stainless-steel, nickel, aluminum, titanium, copper or an alloy thereof. Preferably, aluminum or an alloy thereof may be used.

The binder may include an organic based binder such as a polyvinylidene fluoride-hexafluoropropylene copolymer (PVDF-co-HFP), polyvinylidenefluoride (PVDF), polyacrylonitrile, polymethylmethacrylate, etc., or an aqueous-based binder such as styrene-butadiene rubber (SBR) that may be used with a thickener such as carboxymethyl cellulose (CMC).

For example, a PVDF-based binder may be used as a cathode binder. In this case, an amount of the binder for forming the cathode active material layer may be reduced, and an amount of the cathode active material may be relatively increased. Thus, capacity and power of the lithium secondary battery may be further improved.

The conductive material may be added to facilitate electron mobility between active material particles. For example, the conductive material may include a carbon-based material such as graphite, carbon black, graphene, carbon nanotube, etc., and/or a metal-based material such as tin, tin oxide, titanium oxide, a perovskite material such as LaSrCoO₃ or LaSrMnO₃, etc.

The cathode active material layer 110 included in the cathode 100 may maintain a BET specific surface area within a predetermined range after repeating cycles of charging and discharging. In exemplary embodiments, the BET specific surface area of the cathode active material after repeating 300 cycles of charging of 100% state of charge (SOC) and discharging at a temperature in a range from 25° C. to 45° C. may be in a range from 1.5 m²/g to 2.6 m²/g.

In each cycle, a charging condition may be 1.0 C and 4.2V in a CC (Constant Current)/CV (Constance Voltage) mode, and a discharging condition may be 1.0 C and 2.5V in a CC mode.

In the BET specific surface area range of the cathode active material layer 110 after the above-described 300 cycles, a pore volume of the cathode active material layer may be adjusted to a predetermined range by, e.g., repeated pressing process to be described later to prevent a gas generation due to a side reaction with an electrolyte more effectively. Thus, high-temperature storage properties may be improved, and damages to the cathode active material due to the gas generation during repeated charging/discharging may be suppressed. Accordingly, sufficient high-temperature stability and high-capacity retention may be achieved even when the above-described high-Ni composition is employed.

For example, if the BET specific surface area of the cathode active material layer 110 exceeds 2.6 m²/g after the 300 cycles, the gas generation may be accelerated due to the side reaction with the electrolyte and the life-span property may be deteriorated. If the BET specific surface area of the cathode active material layer 110 is less than 1.5 m²/g after the 300 cycles, an impregnation property of the cathode active material layer 110 with the electrolyte may be excessively reduced, which may cause a reduction of capacity.

Preferably, the BET specific surface area of the cathode active material layer 110 after the 300 cycles may be in a range from 1.5 m²/g to 2.3 m²/g, more preferably, 1.7 m²/g to 2.3 m²/g.

In some embodiments, the pore volume of the cathode active material layer 110 after the 300 cycles may be in a range of 0.01 cm³/g to 0.018 cm³/g. In the pore volume range, the side reaction of the electrolyte due to an increase of a distribution of mesopores in the cathode active material layer 110 may be effectively prevented.

In a preferable embodiment, the pore volume of the cathode active material layer 110 after the 300 cycles may be in a range from 0.01 cm³/g to 0.016 cm³/g.

In some embodiments, an increasing ratio of the BET specific surface area after the 300 cycles of the cathode active material layer 110 relative to the BET specific surface area after the first cycle (a single cycle) may be 50% or less. Preferably, the increasing ratio of the BET specific surface area may be from 20% to 50%. If the increasing ratio in the above range is maintained, the gas generation suppression/high temperature capacity retention may be more effectively implemented without excessively degrading the capacity property of the cathode active material layer 110.

The above-described BET specific surface area and pore volume properties of the cathode active material layer 110 after the 300 cycles may be implemented by adjusting a mixture density after pressing, the BET specific surface area and pore volume before/after pressing, etc.

According to exemplary embodiments, the mixture density after pressing of the cathode 100 may be less than 3.8 g/cc, e.g., 3 g/cc or more and less than 3.8 g/cc.

If the mixture density is 3.8 g/cc or more, the pore formation due to particle cracks may be excessively caused in the pressing process for forming the cathode active material layer 110. For example, the gas generation may be caused by the side reaction with the electrolyte due to an increase of the distribution of mesopores in the cathode active material layer 110.

If the mixture density is less than 3 g/cc, sufficient active sites from the cathode 100 may not be achieved, and thus high-capacity property may not be sufficiently implemented.

In a preferable embodiment, the mixture density may be greater than or equal to 3.5 g/cc and less than 3.8 g/cc, more preferably greater than 3.6 g/cc and less than 3.8 g/cc.

Within the above range, the reduction of chemical stability due to the side reaction with the electrolyte may be prevented while sufficiently implementing the high capacity of the cathode active material from the high-Ni composition as described above

In exemplary embodiments, the BET specific surface area of the cathode active material layer 110 (e.g., the BET specific surface area after pressing) may be from 1.5 m²/g to 2.0 m²/g.

If the BET specific surface area of the cathode active material layer 110 exceeds 2.0 m²/g, side reactions may be caused by an increase of a contact area with the electrolyte, and thus damages may be accelerated and the life-span of the cathode active material may be reduced due to the gas generation during repeated charging/discharging. If the BET specific surface area of the cathode active material layer 110 is less than 1.5 m²/g, the impregnation property of the cathode active material layer 110 with the electrolyte may be degraded, which may cause a capacity reduction.

In a preferable embodiment, the BET specific surface area of the cathode active material layer 110 may be in a range from 1.6 m²/g to 1.9 m²/g.

The BET specific surface area before pressing may be adjusted to obtain the above-described BET specific surface area of the cathode active material layer after pressing. In some embodiments, the BET specific surface area of the cathode active material layer 110 before pressing may be in a range from 0.5 m²/g to 1.0 m²/g, preferably in a range from 0.7 m²/g to 1.0 m²/g.

In an embodiment, an increase ratio of the BET specific surface area after pressing relative to the BET specific surface area before pressing of the cathode active material layer 110 may be in a range from 100% to 200%.

For example, if the increasing ratio of the BET specific surface area after pressing is less than 100%, a contact between the cathode active material and a carbon-based conductive material in the electrode may be insufficient, and voids may occur between the active material particles. Accordingly, an electrochemical performance may be degraded due to a restricted electron movement.

If the increasing ratio of the BET specific surface area after pressing exceeds 200%, cracks in the active material particles may occur due to an excessive pressing. Accordingly, the performance of the cathode active material may be deteriorated due to the side reaction between the active material particles and the electrolyte.

Preferably, the increase ratio of the BET specific surface area after pressing relative to the

BET specific surface area before pressing of the cathode active material layer 110 may be in a range from 100% to 150%, more preferably from 120% to 150%.

In some embodiments, a pore volume after pressing of the cathode active material layer 110 may be in a range of 0.009 cm³/g to 0.015 cm³/g. In the pore volume range, the side reaction of the electrolyte due to the increase of mesopore distribution in the cathode active material layer 110 may be effectively suppressed.

In a preferable embodiment, the pore volume of the cathode active material layer 110 may be in the range of 0.009 cm³/g to 0.013 cm³/g.

The above-described mixture density, specific surface area and pore volume of the cathode active material layer 110 may be controlled though, e.g., a particle size of the cathode active material in a cathode slurry, a viscosity of the slurry for forming the cathode active material layer 110, a coating speed/thickness, a pressure in the pressing/the number of pressing, etc.

In some embodiments, the cathode active material layer 110 may be formed by repeating a plurality of pressing (e.g., a roll press) processes. For example, the coated cathode slurry coated may be pre-pressed by a first pressing process. Subsequently, a thickness of an electrode may be checked with an inner micrometer to measure a preliminary mixture density value. Thereafter, a second pressing process may be performed by changing roll press conditions according to the measured value such that a target mixture density may be obtained to form the cathode active material layer 110.

In some embodiments, an average particle diameter (e.g., D50 from a volumetric cumulative volume particle size distribution) of the cathode active material may be in a range from 3 μm to 15 μm.

The anode 130 may include an anode current collector 125 and an anode active material layer 120 formed by coating an anode active material on the anode current collector 125.

The anode active material may include any widely known material capable of adsorbing and desorbing lithium ions without any particular limitation. For example, a carbon-based material such as a crystalline carbon, an amorphous carbon, a carbon composite material, a carbon fiber; a lithium alloy; a silicon (Si)-based compound or tin may be used.

The amorphous carbon may include a hard carbon, cokes, a mesocarbon microbead (MCMB), a mesophase pitch-based carbon fiber (MPCF), etc.

The crystalline carbon may include a graphite-based material such as natural graphite, graphitized cokes, graphitized MCMB, graphitized MPCF, etc. The lithium alloy may further include aluminum, zinc, bismuth, cadmium, antimony, silicon, lead, tin, gallium, indium, etc.

The silicon-based compound may include, e.g., silicon oxide (SiOx, 0<x<2) or a silicon-carbon composite compound such as silicon carbide (SiC).

For example, a slurry may be prepared by mixing and stirring the anode active material with a binder, a conductive material, a thickener in a solvent. The slurry may be coated on the anode current collector 125, and then dried and pressed to form the anode 130.

The binder and the conductive agent substantially the same as or similar to those used in the cathode active material layer 110 may also be used in the anode. In some embodiments, the binder for forming the anode may include, e.g., an aqueous binder such as styrene-butadiene rubber (SBR) for compatibility with the carbon-based active material, and may be used together with a thickener such as carboxymethyl cellulose (CMC).

The separation layer 140 may be interposed between the cathode 100 and the anode 130. The separation layer 140 may include a porous polymer film prepared from, e.g., a polyolefin-based polymer such as an ethylene homopolymer, a propylene homopolymer, an ethylene/butene copolymer, an ethylene/hexene copolymer, an ethylene/methacrylate copolymer, or the like. The separation layer 140 may also include a non-woven fabric formed from a glass fiber with a high melting point, a polyethylene terephthalate fiber, or the like

In some embodiments, an area and/or a volume of the anode 130 (e.g., a contact area with the separation layer 140) may be greater than that of the cathode 100. Thus, lithium ions generated from the cathode 100 may be easily transferred to the anode 130 without a loss by, e.g., precipitation or sedimentation.

In exemplary embodiments, an electrode cell may be defined by the cathode 100, the anode 130 and the separation layer 140, and a plurality of the electrode cells may be stacked to form an electrode assembly 150 that may have e.g., a jelly roll shape. For example, the electrode assembly 150 may be formed by winding, laminating or folding the separation layer 140.

The electrode assembly 150 may be accommodated together with an electrolyte in a case 160 to define a lithium secondary battery. In exemplary embodiments, a non-aqueous electrolyte may be used as the electrolyte.

For example, the non-aqueous electrolyte solution may include a lithium salt and an organic solvent. The lithium salt may be represented by Li⁺X⁻. An anion of the lithium salt X⁻ may include, e.g., F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc.

The organic solvent may include, e.g., propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethyl sulfoxide, acetonitrile, dimethoxy ethane, diethoxy ethane, vinylene carbonate, sulfolane, gamma-butyrolactone, propylene sulfite, tetrahydrofuran, etc. These may be used alone or in a combination thereof.

As illustrated in FIG. 1, electrode tabs (a cathode tab and an anode tab) may protrude from the cathode current collector 105 and the anode electrode current collector 125 included in each electrode cell to one side of the case 160. The electrode tabs may be welded together with the one side of the case 160 to be connected to an electrode lead (a cathode lead 107 and an anode lead 127) extending or exposed to an outside of the case 160.

The lithium secondary battery may be manufactured in, e.g., a cylindrical shape using a can, a square shape, a pouch shape or a coin shape.

Hereinafter, preferred embodiments are proposed to more concretely describe the present invention. However, the following examples are only given for illustrating the present invention and those skilled in the related art will obviously understand that various alterations and modifications are possible within the scope and spirit of the present invention. Such alterations and modifications are duly included in the appended claims.

### EXAMPLES AND COMPARATIVE EXAMPLES

LiNi_{0.8}Co_{0.1}Mn_{0.1}O₂ having an average particle diameter in a range of 3 μm to 17 μm was prepared as a cathode active material. The cathode active material, Denka Black as a conductive material and PVDF as a binder were mixed in a mass ratio of 95.5:3:1.5, respectively, and N-methyl-2-pyrrolidone (NMP) was added in an appropriate amount to prepare a cathode active material slurry. The cathode active material slurry was coated on both surfaces of an aluminum foil (thickness: 20 μm) as a current collector, dried at 120° C. and pressed using a roll press twice to prepare a cathode.

After the roll pressing, a thickness of the electrode was adjusted to about 110 μm including the aluminum current collector, and a mixture density of the cathode was 3.70 g/cm³.

An anode slurry containing 93 wt % of natural graphite as an anode active material, 5 wt % of KS6 as a flake type conductive material, 1 wt % of styrene-butadiene rubber (SBR) as a binder and 1 wt % of carboxymethyl cellulose (CMC) as a thickener was prepared. The anode slurry was coated on a copper substrate, dried and pressed to prepare an anode.

The cathode and the anode prepared as described above were each notched by a predetermined size, and stacked with a separator (polyethylene, thickness: 25 μm) interposed therebetween to form an electrode cell. Each tab portion of the cathode and the anode was welded. The welded cathode/separator/anode assembly was inserted in a pouch, and three sides of the pouch except for an electrolyte injection side were sealed. The tab portions were also included in sealed portions. An electrolyte was injected through the electrolyte injection side, and then the electrolyte injection side was also sealed. Subsequently, the above structure was impregnated for more than 12 hours to fabricate a secondary battery of Example 1.

The electrolyte was prepared by forming 1M LiPF₆ solution in a mixed solvent of ethylene carbonate (EC)/ethyl methyl carbonate (EMC)/diethylene carbonate (DEC) (25/45/30; volume ratio), and then adding 1 wt % of vinylene carbonate, 0.5 wt % of 1,3-propensultone (PRS) and 0.5 wt % of lithium bis(oxalato)borate (LiBOB).

As shown in Table 1, secondary batteries of Examples and Comparative Examples were prepared by manufacturing electrodes having a mixture density from 3.5 g/cm³ to 3.8 g/cm³, and a specific surface area and a pore volume of each electrode according to the mixture density was confirmed by a BET measurement.

Specifically, the roll press was repeated twice to adjust the mixture density of the electrode including the cathode active material having different particle size distribution. A roll press was performed once (a first press), and then a thickness of the electrode was checked using an inner micrometer to measure a mixture density. Press conditions were modified based on the measured mixture density, and a roll press was performed again (a second press) based on the modified conditions such that a target level of a mixture density was obtained.

Methods for measuring the mixture density and the specific surface area/pore volume are as follows.

### (1) Measurement of Mixture Density

After the second press process, a thickness, a length and a width of the electrode were measured using a micrometer to calculate a volume, and a mixture density was calculated using a mixture weight value.

### (2) Measurement of Specific Surface Area/Pore Volume

The specific surface area and the pore volume were measured using an equipment ASAP2420 (Micromeritics), nitrogen as an adsorption gas and helium as a carrier gas based on a BET relative pressure measurement of 5 predefined points by a continuous flow method

Specifically, 2 g of each cathode active material layer sample was collected before and after the pressing and heated at a temperature of 250° C., and internal moisture and gas were removed to 10 μmHg or less. Thereafter, the mixture was cooled to a liquid nitrogen temperature to adsorb a nitrogen/helium mixed gas, then heated to room temperature to desorb the adsorbed nitrogen gas. The amount of the gas was detected by a thermal conductivity detector to calculate the specific surface area and pore volume of the sample.

The measurement results are shown in Table 1 below.

TABLE 1

| | | specific | specific | | |
|---|---|---|---|---|---|
| | | surface | surface | increase ratio | |
| | | area of | area of | of specific | pore |
| | | electrode | electrode | surface area * | volume |
| | Mixture | (after | (before | (after press- | after |
| | Density | press) | press) | before press)/ | press |
| | (g/cm³) | (m²/g) | (m²/g) | (before press) | (cm³/g) |
| Example 1 | 3.7 | 1.78 | 0.71 | 150% | 0.0120 |
| Example 2 | 3.7 | 1.87 | 0.74 | 152% | 0.0130 |
| Example 3 | 3.7 | 1.89 | 0.77 | 145% | 0.0122 |
| Example 4 | 3.52 | 1.60 | 0.71 | 125% | 0.0097 |
| Example 5 | 3.6 | 1.65 | 0.75 | 120% | 0.0102 |
| Comparative | 3.8 | 2.18 | 0.68 | 220% | 0.0159 |
| Example 1 | | | | | |
| Comparative | 3.8 | 2.22 | 0.71 | 212% | 0.0148 |
| Example 2 | | | | | |
| Comparative | 3.8 | 2.28 | 0.73 | 212% | 0.0156 |
| Example 3 | | | | | |

### Experimental Example

### (1) Measurement of BET Specific Surface Area/Pore Volume Measurement After 300 Cycles

The secondary batteries of Examples and Comparative Examples were charged to SOC100% (CC-CV 1.0 C 4.2V CUT-OFF) and discharged (CC: 1.0 C 2.5V CUT-OFF) in a chamber at 25° C. (Example 1, Example 4, Example 5 and Comparative Example 1) or at 45° C. (Example 2 and Comparative Example 2) as one cycle, and total 300 cycles were repeated.

After repeating the cycles, the lithium secondary battery was disassembled to obtain the cathode. The salts or electrolyte on a surface of the cathode was sufficiently washed and removed using a carbonate-based solvent such as dimethyl carbonate (DMC) or ethylmethyl carbonate (EMC), and the solvent was evaporated by a vacuum drying at room temperature.

Thereafter, the specific surface area and pore volume of the sample in the cathode active material layer were calculated as described above using the equipment of ASAP2420 (Micromeritics).

### (2) Measurement of Capacity Retention

As described above, the 300 cycles of SOC100% charging (CC-CV 1.0 C 4.2V CUT-OFF) and discharging (1.0 C 2.5V CUT-OFF) in the chamber at 25° C. (Example 1, Example 4, Example 5, Comparative Example 1) or at 45° C. (Example 2 and Comparative Example 2) were performed for the secondary batteries of Examples and Comparative Examples. Ratios of a discharge capacity at the 300th cycle relative to a discharge capacity at the first cycle were calculated.

### (3) Measurement of High-Temperature Gas Generation

The secondary batteries of Example 3 and Comparative Example 3 were stored in in a chamber at 60° C. for 20 weeks under the SOC100% charged (CC-CV 1.0 C 4.2V CUT-OFF) state, and then a gas in the secondary battery was separated using a jig for GC analysis to measure an amount of gas generated after the high temperature storage at 100% SOC. Additionally, the 300 cycles of SOC 100% for the secondary batteries of Example 2 and Comparative Example 2 were performed in a chamber at 45° C., and then an amount of gas generated in the secondary batteries was measured by the same method.

The results are shown in Tables 2 and 3 below.

TABLE 2

| | specific surface area of electrode | | | |
|---|---|---|---|---|
| | | after single | | pore volume |
| | after 300 | charge/ | Increase | after 300 |
| | cycles | discharge | ratio | cycles |
| | (m²/g) | (m²/g) | (%) | (cm³/g) |
| Example 1 | 2.15 | 1.51 | 42 | 0.0144 |
| Example 2 | 2.29 | 1.53 | 50 | 0.0154 |
| Example 3 | — | — | — | — |
| Example 4 | 1.71 | 1.35 | 27 | 0.0117 |
| Example 5 | 1.93 | 1.44 | 34 | 0.0122 |
| Comparative | 2.63 | 1.64 | 60 | 0.0154 |
| Example 1 | | | | |
| Comparative | 2.9 | 1.64 | 77 | 0.0187 |
| Example 2 | | | | |
| Comparative | — | — | — | — |
| Example 3 | | | | |

TABLE 3

| | 25° C. | 45° C. | gas generation | gas generation |
|---|---|---|---|---|
| | capacity | capacity | after 300 cycles | after storage |
| | retention | retention | at 45° C. | at 60° C. |
| | (%) | (%) | (mL) | (mL) |
| Example 1 | 96.5 | — | — | — |
| Example 2 | — | 95.5 | 22 | — |
| Example 3 | — | — | — | 84 |
| Example 4 | 93.3 | — | — | — |
| Example 5 | 95 | — | — | — |
| Comparative | 92.8 | — | — | — |
| Example 1 | | | | |
| Comparative | — | 91 | 30 | — |
| Example 2 | | | | |
| Comparative | — | — | — | 120 |
| Example 3 | | | | |

Referring to Tables 2 and 3, the BET specific surface area in a range from 1.5 m²/g to 2.6 m²/g after the 300 cycles was obtained from all Examples.

In the case of Examples 1 and 2, the BET specific surface area of the cathode was 1.51 m²/g and 1.53 m²/g after the single charge/discharge at 25° C. and 45° C. in the mixture density level of 3.7 g/cm³, and the BET specific surface area after the 300 cycles at 25° C. and 45° C. was 2.15 m²/g and 2.29 m²/g, respectively.

Accordingly, the increase ratio of the BET specific surface area after the 300 cycles at 25° C. and 45° C. relative to the single charge and discharge (the 1st cycle) were 42% and 50%, respectively.

In the case of Comparative Example 1 where the mixture density was 3.8 g/cc and the electrode specific surface area (m²/g) exceeded 2.0 m²/g, the increase ratio of the specific surface area after the 300 cycles was remarkably increased compared to those from Examples 1 and 2, and the capacity retention at 25° C. was degraded compared to that of Example 1.

In Example 2, the pore volume of the cathode active material layer was maintained at 0.016 cm³/g or less after the 300 cycles at 45° C. Accordingly, the capacity retention improved by 4% or more compared to that of Comparative Example 2 was obtained, and the amount of gas generated after the 300 cycles was also reduced by 25% compared to that of Comparative Example 2.

In Example 3, the amount of gas generated after the storage at 60° C. was remarkably reduced compared to that of Comparative Example 3. In Examples 4 and 5 having the mixture density of 3.6 g/cc or less, an impregnation property of the cathode active material layer with the electrolyte was relatively degraded compared to that of Example 1, and the capacity retention was slightly decreased.

### (4) Evaluation on Volume Distribution According to Pore Diameter

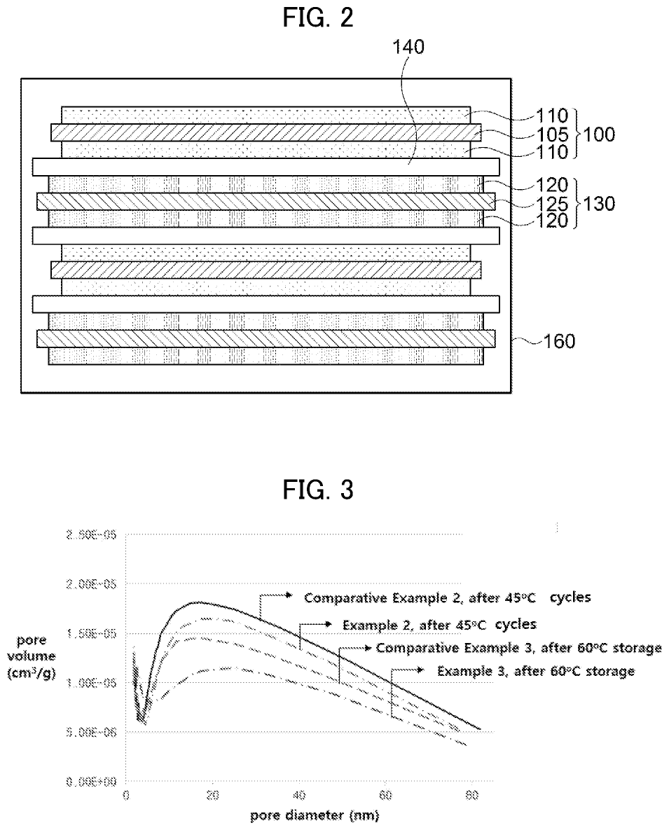

FIG. 3 is a graph showing a change of a volume distribution according to a distribution of a pore diameter (dV/dD). Specifically, FIG. 3 was obtained from the results of BET adsorption curves of the cathodes after evaluating the capacity retention after the 300 cycles at 45° C. (Example 2 and Comparative Example 2) and the cathodes after measuring the amount of gas generation after the 60° C. high temperature storage for 20 weeks.

Referring to FIG. 3, in Comparative Examples 2 and 3, after the 45° C. cycles and the 60° C. storage, the pore distributions corresponding to mesopores having a diameter from 10 nm to 50 nm was remarkably increased compared to those of Examples 2 and 3, respectively. A degree of crack generation in the cathode active material can be quantitatively predicted using the mesopores.

Accordingly, it is predicted that deterioration of life-span properties and chemical stability at high temperature were caused by the cracks generated after pressing in the cathode included in Comparative Examples.

What is claimed is:

1. A lithium secondary battery, comprising:
a cathode comprising a cathode current collector and a cathode active material layer formed on the cathode current collector, the cathode active material layer including lithium-transition metal composite oxide particles; and
an anode facing the cathode,
wherein a BET specific surface area after 300 cycles of the cathode active material layer is in a range from 1.5 m²/g to 2.6 m²/g, when a single cycle comprises charging at 1.0 C and 4.2V in a CC/CV mode to a 100% state of charge (SOC) and then discharging at 1.0 C and 2.5V in a CC mode in a temperature range from 20° C. to 45° C.

2. The lithium secondary battery according to claim 1, wherein the BET specific surface area of the cathode active material layer after the 300 cycles is in a range from 1.5 m²/g to 2.3 m²/g.

3. The lithium secondary battery according to claim 1, wherein an increase ratio of the BET specific surface area of the cathode active material layer after the 300 cycles relative to a BET specific surface area of the cathode active material layer after the single cycle is 50% or less.

4. The lithium secondary battery according to claim 1, wherein an increase ratio of the BET specific surface area of the cathode active material layer after the 300 cycles relative to a BET specific surface area of the cathode active material layer after the single cycle is from 20% to 50%.

5. The lithium secondary battery according to claim 1, wherein a pore volume of the cathode active material layer after the 300 cycles is in a range from 0.01 cm³/g to 0.018 cm³/g.

6. The lithium secondary battery according to claim 1, wherein a pore volume of the cathode active material layer after the 300 cycles is in a range from 0.01 cm³/g to 0.016 cm³/g.

7. The lithium secondary battery according to claim 1, wherein the lithium-transition metal composite oxide particle is represented by Chemical Formula 1:
LiₓNi_{1-y}M_{y}O_{2+z} [Chemical Formula 1]
wherein, in Chemical Formula 1, 0.9≤x≤1.2, 0≤y≤0.7, −0.1≤z≤0.1, and M includes at least one element selected from the group consisting of Na, Mg, Ca, Y, Ti, Hf, V, Nb, Ta, Cr, Mo, W, Mn, Co, Fe, Cu, Ag, Zn, B, Al, Ga, C, Si, Sn and Zr.

8. The lithium secondary battery according to claim 7, wherein a molar ratio of nickel in the lithium-transition metal composite oxide particle is 0.8 or more.

9. The lithium secondary battery according to claim 1, wherein a mixture density of the cathode active material layer is less than 3.8 g/cc.

10. The lithium secondary battery according to claim 1, wherein a mixture density of the cathode active material layer is greater than 3.6 g/cc and less than 3.8 g/cc.

11. A method of fabricating a cathode for a lithium secondary battery, comprising:
coating a slurry comprising a cathode active material that includes lithium-transition metal composite oxide particles on a cathode current collector to form a preliminary cathode active material layer; and
forming a cathode active material layer by pressing the preliminary cathode active material layer so that the cathode active material layer has a mixture density of less than 3.8 g/cc and a BET specific surface area in a range from 1.5 m²/g to 2.0 m²/g.

12. The method of claim 11, wherein the BET specific surface area of the preliminary cathode active material layer before the pressing is from 0.5 m²/g to 1.0 m²/g.

13. The method according to claim 11, wherein an increase ratio of the BET specific surface area of the cathode active material layer after the pressing relative to the BET specific surface area of the preliminary cathode active material layer before the pressing is in a range from 100% to 200%.

14. The method according to claim 11, wherein an increase ratio of the BET specific surface area of the cathode active material layer after the pressing relative to the BET specific surface area of the preliminary cathode active material layer before the pressing is in a range from 100% to 150%.

15. The method of claim 11, wherein a pore volume of the cathode active material layer after the pressing is in a range from 0.009 cm³/g to 0.015 cm³/g.

16. The method according to claim 11, wherein the forming the cathode active material layer comprises:
performing a first press of the slurry; and
performing a second press by changing press conditions to have a target mixture density or a target BET specific surface area based on a mixture density or a BET specific surface area measured after the first press.
